(19) United States
(12) Patent Application Publication
(10) Pub. No.: US 2008/0203053 A1
(43) Pub. Date: Aug. 28, 2008

(54) Method for manufacturing magnetic recording medium, stamper, transferring apparatus, and method for forming resin mask

(75) Inventors: Narutoshi Fukuzawa, Tokyo (JP); Kazuhiro Hattori, Tokyo (JP); Minoru Fujita, Tokyo (JP); Daisuke Yoshitoku, Kawasaki-shi (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/071,463

(22) Filed: Feb. 21, 2008

(30) Foreign Application Priority Data
Feb. 26, 2007 (JP) 2007-045815

(51) Int. Cl. C23F 1/00; B41C 3/08

(52) U.S. Cl. 216/12; 216/22; 101/401.1

(57) ABSTRACT

A reliable magnetic recording medium manufacturing method is provided in which a resin material used for processing a recording layer into a concavo-convex pattern can be removed reliably. In the magnetic recording medium manufacturing method, an energy ray curable resin material is spread over a continuous recording layer. Then, a stamper having a predetermined concavo-convex pattern is brought into contact with the resin material to transfer the concavo-convex pattern to the resin material, and the resin material is irradiated with energy rays such that the irradiation energy on a portion excluding the edge portion of the resin material is greater than that on the edge portions. The curing reaction proceeds to a greater extent in the portion excluding the edge portions than in the edge portions. Then, the resin material is etched and removed such that more resin material is removed from the edge portions than from the other portion.

### BACKGROUND OF THE INVENTION

1. Field of the Invention

The present invention relates to a method for manufacturing a magnetic recording medium having a recording layer formed to have a concavo-convex pattern, to a stamper and a transferring apparatus used in the method, and to a method for forming a resin mask.

2. Description of the Related Art

Conventionally, a significant improvement in the areal density of magnetic recording media such as hard disks has been achieved by, for example, reducing the size of magnetic particles constituting a recording layer, changing materials, and improving the precision of head processing. A further improvement in the areal density is expected in the future.

However, problems such as the limit of head processing, incorrect recording of information on a track adjacent to a target recording track by the broadening of a recording magnetic field and crosstalk during reproduction have become apparent. Therefore, the improvement of the areal density by conventional improvement techniques has reached the limit. In view of this, discrete track media and patterned media having a recording layer divided into a plurality of recording elements have been proposed as candidates for magnetic recording media in which a further improvement in the areal density can be achieved (for example, Japanese Patent Application Laid-Open No. Hei 9-97419).

IBE (ion beam etching) in which an inert gas such as Ar is used and RIE (reactive ion etching) in which CO gas mixed with a nitrogen-containing gas such as NH₃ gas is used as a reaction gas can be used as the technique for processing the recording layer into a concavo-convex pattern.

Specifically, a resin material is deposited over a continuous recording layer of a workpiece including the recording layer and other layers formed over a substrate, and the resin material is processed into a predetermined concavo-convex pattern by means of an imprint method. Then, the recording layer can be processed into a concavo-convex pattern according to the concavo-convex pattern of the resin material. Moreover, another technique has been proposed in which one or a plurality of mask layers are formed between the recording layer and the layer of the resin material and then the mask layer(s) and the recording layer are processed to have a concavo-convex pattern one after another according to the concavo-convex pattern of the resin material.

As the method for forming the resin layer over the recording layer, a spin coating method, for example, may be used. Generally, a center hole for chucking is formed in the substrate of a magnetic recording medium such as a hard disk. In this method, the resin in a fluid state is supplied to the circumference of the center hole, and the substrate is rotated, whereby the resin is spread over the entire surface of the substrate by the centrifugal force.

Incidentally, a filling material is deposited over the recording layer formed into the concavo-convex pattern to fill the concave portions between recording elements, and then the excess filling material above the recording elements is removed by means of IBE or the like, whereby the surfaces of the recording elements and the filling material can be flattened.

In order to manufacture a magnetic recording medium in which the amount of undesirable substances is small, it is desirable to completely remove the resin material remaining over the recording elements after the recording layer is processed into the concavo-convex pattern. In particular, in order to manufacture a magnetic recording medium having a flat surface, it is desirable to completely remove the resin material remaining over the recording elements before the filling material is deposited over the recording layer formed into the concavo-convex pattern.

However, in the step of spreading the resin material, when the resin is spread over the substrate by means of, for example, a spin coating method, the thickness of the resin material may be different depending on the position on the substrate, and a part of the resin material maybe formed to have a significantly increased thickness. For example, the thickness of the resin material in the edge portion around the center hole of the substrate (around the starting position of spreading) and in the outer circumferential edge portion can be several times to several tens of times that in the other portion. Furthermore, also when the resin material is spread by means of a dipping method, the thickness of the resin material in the edge portion around the center hole of the substrate and in the outer circumferential edge portion can be greater than that in the other portion.

Therefore, the resin material may not be removed completely and may remain over the recording elements even after the recording layer is processed into the concavo-convex pattern. In such a case, there is a concern that the resin remains in the completed product. Moreover, the resin material remaining over the recording elements can cause various problems in downstream steps such as a filling material depositing step and a flattening step. In other words, a reliability problem arises. The thickness of edge portions of the resin material can be reduced to some extent by pressing the edge portions with a stamper when the concavo-convex pattern is transferred to the resin material by means of an imprint method. However, the edge portions of the resin material can be formed to a thickness of several times to several tens of times that of the other portion. Therefore, it is difficult, only by pressing the edge portions with the stamper, to sufficiently reduce the thickness of the edge portions to the extent that the excess resin material can be completely removed after the recording layer is formed into the concavo-convex pattern.

### SUMMARY OF THE INVENTION

In view of the foregoing problems, various exemplary embodiments of the invention provide a reliable magnetic recording medium manufacturing method in which a resin material used for processing a recording layer into a concavo-convex pattern can be removed reliably, a stamper and a transferring apparatus used in the method, and a method for forming a resin mask.

Various exemplary embodiments of the invention provide a method including: spreading a curable resin material which can be cured by being irradiated with energy rays over a continuous recording layer of a workpiece; bringing a stamper including a transferring portion having a predetermined concavo-convex pattern formed therein into contact with the resin material to transfer the concavo-convex pattern to the resin material and projecting energy rays onto the resin material such that the irradiation energy of the energy rays is greater on a portion excluding an edge portion of the resin material than on the edge portion, whereby the resin material is cured such that a curing reaction of the resin material proceeds to a greater extent in the portion excluding the edge portion than in the edge portion; and etching the resin material to remove the resin material such that an amount of the resin material removed is greater in the edge portion than in the portion excluding the edge portion.

Furthermore, various exemplary embodiments of the invention provide a stamper including: a base portion which includes a transferring portion having a predetermined concavo-convex pattern formed therein and allows predetermined energy rays to pass therethrough; and a mask capable of shielding an edge portion of a target corresponding to an edge portion of the transferring portion from the energy rays projected onto the target.

Moreover, various exemplary embodiments of the invention provide a transferring apparatus including a stamper stage which can apply a pressure to a target through a stamper including a transferring portion having a predetermined concavo-convex pattern formed therein, allows predetermined energy rays to pass therethrough, and can shield an edge portion of the target corresponding to an edge portion of the transferring portion of the stamper from the energy rays projected onto the target.

Furthermore, various exemplary embodiments of the invention provide a method including: spreading a resin material which can be cured by being irradiated with energy rays over a workpiece; bringing a stamper including a transferring portion having a predetermined concavo-convex pattern formed therein into contact with the resin material to transfer the concavo-convex pattern to the resin material and projecting energy rays onto the resin material such that the irradiation energy of the energy rays is greater on a portion excluding an edge portion of the resin material than on the edge portion, whereby the resin material is cured such that a curing reaction of the resin material proceeds to a greater extent in the portion excluding the edge portion than in the edge portion; and etching the resin material to remove the resin material such that an amount of the resin material removed is greater in the edge portion than in the portion excluding the edge portion.

In the step of spreading the resin material, the edge portions of the resin material, i.e., the resin material around a center hole and in the outer circumferential portion, can be formed to have a thickness significantly greater than that of the other portion. Even in such a case, by projecting energy rays onto the resin material such that the irradiation energy is greater on a portion excluding the edge portions of the resin material than on the edge portions, the resin material can be cured such that the curing reaction of the resin material proceeds to a greater extent in the portion excluding the edge portions than in the edge portions. In this manner, during predetermined etching, the etching rate for the edge portions of the resin material can be greater than the etching rate for the other portion of the resin material. Accordingly, during the etching of the resin material, more resin material can be removed from the edge portions than from the other portion. As described above, by selectively etching the edge portions of the resin material which tend to be thicker than the other portion, the resin material used for processing the recording layer into the concavo-convex pattern can be removed reliably.

Accordingly, various exemplary embodiments of this invention provide a method for manufacturing a magnetic recording medium, comprising: a resin material spreading step of spreading a resin material which can be cured by being irradiated with energy rays over a continuous recording layer of a workpiece; a transferring step of bringing a stamper including a transferring portion having a predetermined concavo-convex pattern formed therein into contact with the resin material to transfer the concavo-convex pattern to the resin material and projecting energy rays onto the resin material such that irradiation energy of the energy rays is greater on a portion excluding an edge portion of the resin material than on the edge portion, whereby the resin material is cured such that a curing reaction of the resin material proceeds to a greater extent in the portion excluding the edge portion than in the edge portion; and a resin material etching step of etching the resin material to remove the resin material such that an amount of the resin material removed is greater in the edge portion than in the portion excluding the edge portion.

Moreover, various exemplary embodiments of this invention provide a stamper comprising: a base portion which includes a transferring portion having a predetermined concavo-convex pattern formed therein and allows predetermined energy rays to pass therethrough; and a mask capable of shielding an edge portion of a target corresponding to an edge portion of the transferring portion from the energy rays projected onto the target.

Furthermore, various exemplary embodiments of this invention provide a transferring apparatus comprising: a stamper stage which can apply a pressure to a target through a stamper including a transferring portion having a predetermined concavo-convex pattern formed therein, allows predetermined energy rays to pass therethrough, and can shield an edge portion of the target corresponding to an edge portion of the transferring portion of the stamper from the energy rays projected onto the target.

Various exemplary embodiments of this invention provide a method for forming a resin mask, the method comprising: a resin material spreading step of spreading a resin material which can be cured by being irradiated with energy rays over a workpiece; a transferring step of bringing a stamper including a transferring portion having a predetermined concavo-convex pattern formed therein into contact with the resin material to transfer the concavo-convex pattern to the resin material and projecting energy rays onto the resin material such that irradiation energy of the energy rays is greater on a portion excluding an edge portion of the resin material than on the edge portion, whereby the resin material is cured such that a curing reaction of the resin material proceeds to a greater extent in the portion excluding the edge portion than in the edge portion; and a resin material etching step of etching the resin material to remove the resin material such that an amount of the resin material removed is greater in the edge portion than in the portion excluding the edge portion.

In the present application, the term “energy rays” is used to refer to a generic term of, for example, electromagnetic waves such as ultraviolet rays and particle beams such as electron beams having the ability to cure a particular resin in a fluid state.

In the present application, the term “irradiation energy” is used to refer to the energy per unit area of the energy rays projected onto the resin material.

In the present application, the term “magnetic recording media” is not limited to media, such as hard disks, floppy (registered trademark) disks, and magnetic tapes, in which magnetism alone is used for recording and reproducing information. This term is also used to refer to magneto-optical recording media, such as MO disks, in which both magnetism and light are used and to heat assisted type recording media in which both magnetism and heat are used for recording and reproducing information.

### BRIEF DESCRIPTION OF THE DRAWINGS

FIG. 1 is a radial cross-sectional view schematically illustrating the structure of a starting body of a workpiece in a magnetic recording medium manufacturing method according to a first exemplary embodiment of the present invention;

FIG. 2 is a radial cross-sectional view schematically illustrating the structure of a magnetic recording medium obtained by processing the workpiece;

FIG. 3 is a flowchart showing the outline of the magnetic recording medium manufacturing method;

FIG. 4 is a radial cross-sectional view schematically illustrating the step of spreading a resin material over the workpiece;

FIG. 5 is a radial cross-sectional view schematically illustrating the shape of the edge portions of the resin material;

FIG. 6 is a partially cross-sectional side view schematically illustrating a stamper, a transferring apparatus, and an irradiation apparatus in the first exemplary embodiment;

FIG. 7 is a plan view schematically illustrating the structure of the stamper;

FIG. 8 is a partially cross-sectional side view schematically illustrating the step of transferring a concavo-convex pattern to the resin material using the stamper;

FIG. 9 is a radial cross-sectional view schematically illustrating the shape of the workpiece in which the edge portions of the resin material are removed;

FIG. 10 is a radial cross-sectional view schematically illustrating the shape of the workpiece having a recording layer processed into a concavo-convex pattern;

FIG. 11 is a radial cross-sectional view schematically illustrating the shape of the workpiece in which a filling material is deposited over the recording layer;

FIG. 12 is a radial cross-sectional view schematically illustrating the shape of the workpiece in which the surfaces of recording elements and the filling material are flattened;

FIG. 13 is a partially cross-sectional side view schematically illustrating a stamper, a transferring apparatus, and an irradiation apparatus according to a second exemplary embodiment of the present invention; and

FIG. 14 is a partially cross-sectional side view schematically illustrating a stamper, a transferring apparatus, and an irradiation apparatus according to a third exemplary embodiment of the present invention.

### DETAILED DESCRIPTION OF THE PREFERRED EMBODIMENTS

Hereinbelow, preferred exemplary embodiments of the present invention will be described in detail with reference to the drawings.

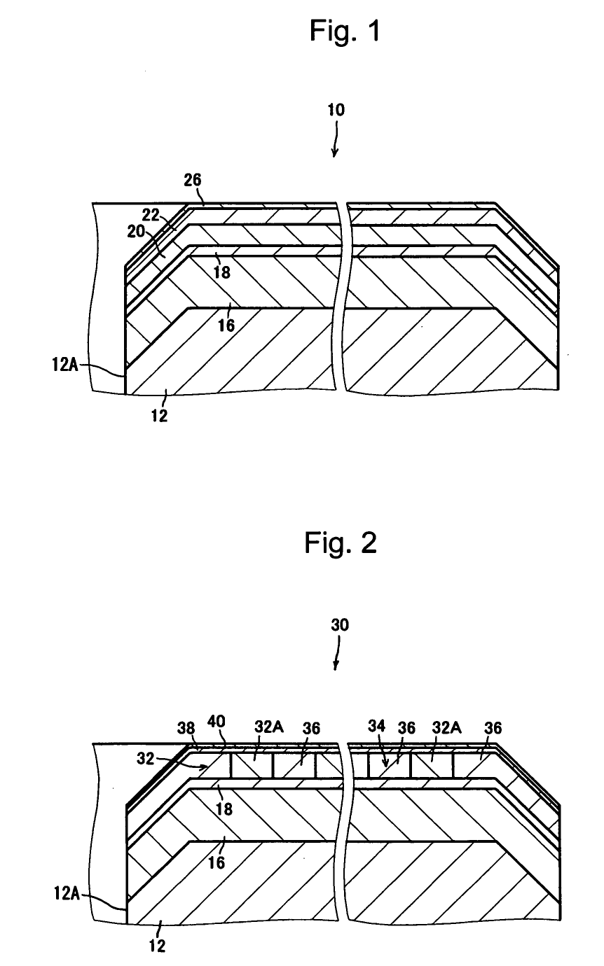

A first exemplary embodiment of the present invention relates to a method for manufacturing a magnetic recording medium. In this method, a starting body of a workpiece 10 shown in FIG. 1 is subjected to processing such as dry etching, and a continuous recording layer is thereby processed into a predetermined line-and-space pattern (data track pattern) shown in FIG. 2 and into a servo pattern (not shown). The method is characterized by a step of transferring, by using a stamper, a concavo-convex pattern to a resin material used for processing the recording layer into a concavo-convex pattern and by a step of etching the resin material formed into the concavo-convex pattern. The descriptions of other components will be omitted as appropriate because they do not seem to be particularly important for understanding of the first exemplary embodiment.

As shown in FIG. 1, the starting body of the workpiece 10 includes a substrate 12, a soft magnetic layer 16, a seed layer 18, a continuous recording layer 20, a first mask layer 22, and a second mask layer 26. These layers are formed over the substrate 12 in that order.

The substrate 12 has a substantially disk-like shape with a center hole 12A. The inner and outer circumferences of the substrate 12 are chamfered by 0.05 to 0.5 (mm) at 45°. For example, the inner and outer circumferences of the substrate 12 are chamfered by 0.2 (mm) at 45°. Glass, Al, Al₂O₃, or the like may be used as the material for the substrate 12.

The soft magnetic layer 16 has a thickness of 50 to 300 nm. An Fe alloy, a Co alloy, or the like may be used as the material for the soft magnetic layer 16.

The seed layer 18 has a thickness of 2 to 40 nm. A nonmagnetic material such as a CoCr alloy, Ti, Ru, a laminate of Ru and Ta, MgO, or the like may be used as the material for the seed layer 18.

The recording layer 20 has a thickness of 5 to 30 nm. A CoCr-based alloy such as a CoCrPt alloy, an FePt-based alloy, a laminate thereof, a material formed of an oxide material, such as SiO₂, and ferromagnetic particles, such as CoPt particles, contained in the oxide material in a matrix form, or the like may be used as the material for the recording layer 20.

The first mask layer 22 has a thickness of 3 to 50 nm. C (carbon) may be used as the material for the first mask layer 22. For example, a hard carbon film, so-called diamond-like carbon (hereinafter referred to as “DLC”), may be used as the material for the first mask layer 22.

The second mask layer 26 has a thickness of 2 to 30 nm. Ni, Cu, Cr, Al, Al₂O₃, Ta, or the like may be used as the material for the second mask layer 26.

A magnetic recording medium 30 is a disk-shaped discrete track medium of a perpendicular recording type having a center hole. In a data area, a recording layer 32 is formed to have a concavo-convex pattern formed by dividing the continuous recording layer 20 into a large number of concentric arc-shaped recording elements 32A arranged at small intervals in the radial direction. FIG. 2 shows this shape. In a servo area, the recording layer 32 is divided into a large number of recording elements in a predetermined servo pattern (not shown). Moreover, concave portions 34 between the recording elements 32A are filled with a filling material 36. A protection layer 38 and a lubrication layer 40 are formed in that order over the recording elements 32A and the filling material 36.

SiO₂, C (carbon), DLC, a resin material, or the like may be used as the material for the filling material 36. The protection layer 38 has a thickness of 1 to 5 nm. DLC may be used as the material for the protection layer 38. The lubrication layer 40 has a thickness of 1 to 2 nm. PFPE (perfluoropolyether) may be used as the material for the lubrication layer 40.

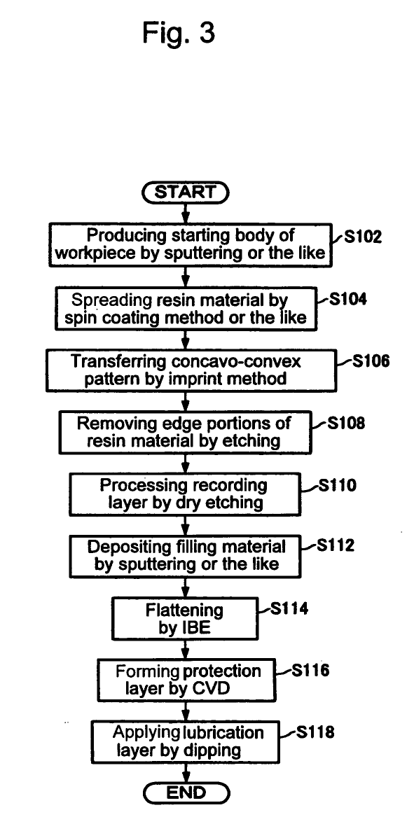

With reference to the flowchart shown in FIG. 3 and other figures, a description will now be given of the method for manufacturing the magnetic recording medium 30.

First, the starting body of a workpiece 10 is produced (S102) The starting body of the workpiece 10 is obtained by forming the soft magnetic layer 16, the seed layer 18, the continuous recording layer 20, the first mask layer 22, and the second mask layer 26 over the substrate 12 in that order by means of sputtering. When DLC is formed as the first mask layer 22, a CVD method is used. The soft magnetic layer 16 may be formed by means of a plating method.

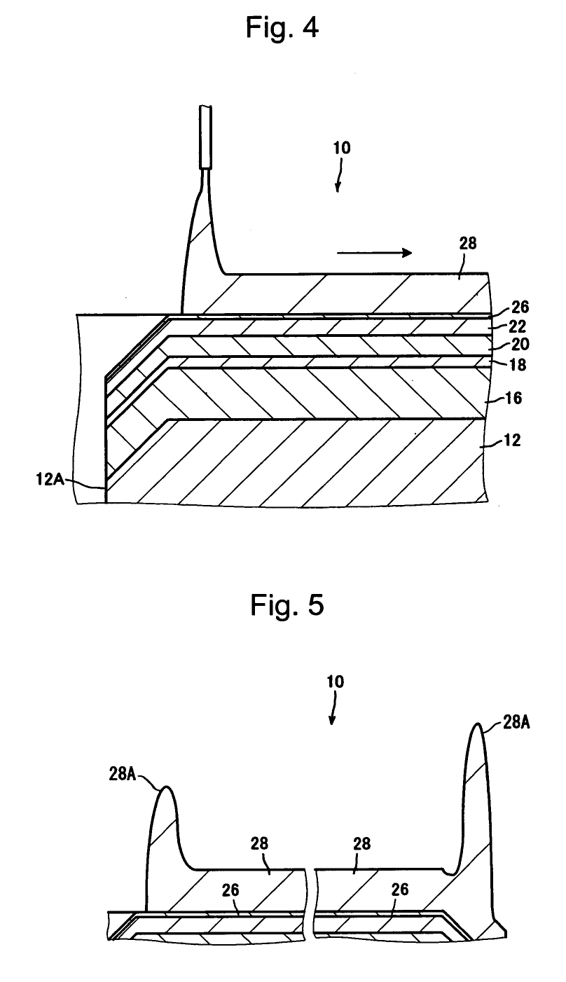

Next, as shown in FIG. 4, a resin material 28 is spread over the second mask layer 26 (being provided over the continuous recording layer 20) to a thickness of 30 to 300 nm by means of a spin coating method (S104). Specifically, a predetermined amount of the resin material 28 is supplied around the center hole 12A. Then, the workpiece 10 is rotated to allow the resin material 28 to spread over the second mask layer 26 by the centrifugal force. Alternatively, the resin material 28 may be spread over the second mask layer 26 by means of a dipping method.

Any energy ray curable resin material, such as a monomer and oligomers of an acrylic-based resin or an epoxy-based resin, which can be cured by being irradiated with energy rays such as ultraviolet rays and contains a photo-polymerization initiator, may be used as the resin material 28. Specifically, such an acrylic resin is polymerized through radical polymerization and can obtained by mixing oligomers of urethane acrylate, epoxy acrylate, silicon acrylate, and/or polyester acrylate and monomers having one to three functional groups, such as trimethylolpropane triacrylate, pentaerythritol triacrylate, hexanediol diacrylate, and hydroxy phenoxy propyl acrylate, while desired properties (curing properties, viscosity, shrinkage on curing, and adhesion properties) are taken into consideration. Furthermore, the epoxy-based energy ray curable resin material is polymerized through cationic polymerization. Examples of such a resin material include bisphenol-based, novolac-based, alicyclic-based, and aliphatic-based resin materials, and these may be used alone or in combination.

When the resin material 28 is spread, the outer and inner edge portions 28A of the resin material 28 tend to be thicker than the other portion as shown in FIG. 5. For example, the edge portions 28A can be formed to a thickness of 1 to 2 μm (1,000 to 2,000 nm).

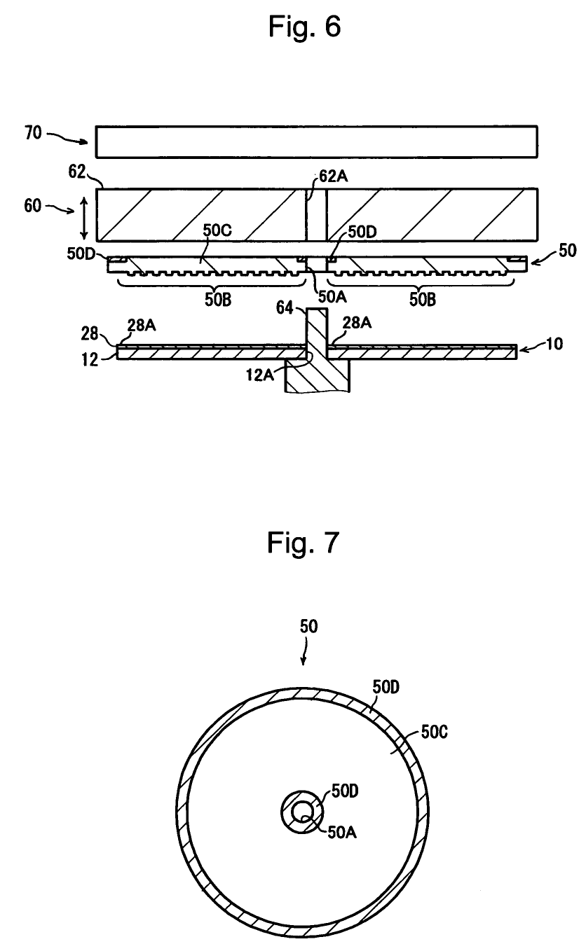

Next, a concavo-convex pattern is transferred to the resin material 28 by means of an imprint method by using a stamper 50, a transferring apparatus 60, and an irradiation apparatus 70 shown in FIG. 6 (S106).

As shown in FIG. 7, the stamper 50 has a substantially disk-like shape with a center hole 50A and includes a base portion 50C and masks 50D. The base portion 50C includes an annular transferring portion 50B having a concavo-convex pattern corresponding to the concavo-convex pattern of the recording layer 20 and allows energy rays such as ultraviolet rays to pass therethrough. The masks 50D can shield the edge portions 28A of the resin material 28, which correspond to the inner and outer edge portions of the transferring portion 50B, from energy rays projected onto the resin material 28 (being a target to be transferred to) of the workpiece 10 through the base portion 50C. A translucent or transparent material such as polyolefin resin, acrylic resin, or glass or a similar material may be used as the material for the base portion 50C. A non-translucent film or coating (which can shield light, particularly in the ultraviolet region (having wavelengths of 400 nm or less)) may be used as the material for the masks SOD. In the first exemplary embodiment, the masks 50D are disposed on the side opposite to the transferring portion 50B of the base portion 50C, and the surfaces of the masks 50D and the base portion 50C form a flat surface with no steps. Note that the masks may be disposed on the transferring portion 50B side of the base portion 50C.

The transferring apparatus 60 includes a stamper stage 62 which can apply pressure to the resin material 28 through the stamper 50. The stamper stage 62 has a substantially disk-like shape with a center hole 62A. As in the base portion 50C of the stamper 50, a translucent or transparent material such as polyolefin resin, acrylic resin, or glass or a similar material may be used as the material for the stamper stage 62. The stamper stage 62 can be moved vertically by means of a driving apparatus (not shown).

Moreover, the transferring apparatus 60 includes a holder 64 which fits into the center hole 12A of the workpiece 10 to hold the workpiece 10. The holder 64 can also fit into the center hole 50A of the stamper 50 and into the center hole 62A of the stamper stage 62. Accordingly, the holder 64 is configured to adjust the positions of the workpiece 10, the stamper 50, and the stamper stage 62 such that the centers thereof coincide with each other.

The irradiation apparatus 70 is placed above the stamper stage 62 so as to project energy rays such as ultraviolet rays downward.

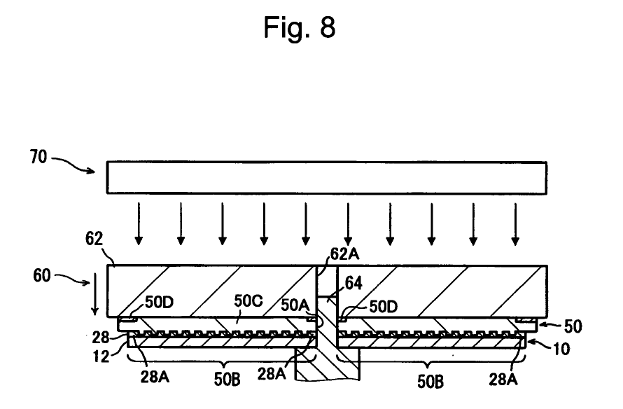

As shown in FIG. 8, the stamper 50 is placed on the workpiece 10 held by the holder 64 such that the transferring portion 50B comes into contact with the resin material 28. Subsequently, the stamper stage 62 is moved down to apply pressure to the resin material 28 through the stamper 50 to transfer the concavo-convex pattern of the transferring portion 50B to the resin material 28. Then, the resin material 28 is irradiated with the energy rays such as ultraviolet rays from the irradiation apparatus 70 through the stamper stage 62 and the stamper 50 and is thereby cured. At this time, a part of the energy rays is shielded by the masks 50D, and therefore the edge portions 28A of the resin material 28 are not irradiated with the energy rays. Specifically, the resin material 28 is irradiated with the energy rays such that the irradiation energy is grater on a portion excluding the edge portions 28A of the resin material 28 than on the edge portions 28A. Accordingly, the resin material 28 is cured such that the curing reaction of the resin material 28 proceeds to a greater extent in the portion excluding the edge portions 28A than in the edge portions 28A. More specifically, in the portion excluding the edge portions 28A, the resin material 28 increases in molecular weight during polymerization and/or crosslinking reaction and is transformed into a solid state. Meanwhile, the polymerization and/or crosslinking reaction are suppressed in the edge portions 28A. Note that the irradiation energy is the product of the energy per unit time of the energy rays and the irradiation time. In FIG. 8, the arrows below the irradiation apparatus 70 schematically represent the direction of irradiation with the energy rays. Furthermore, in FIGS. 6 and 8, the layers between the substrate 12 and the resin material 28 in the workpiece 10 are not illustrated. After the resin material 28 in the portion excluding the edge portions 28A is cured, the stamper stage 62 is moved up, and the stamper 50 is separated from the resin material 28.

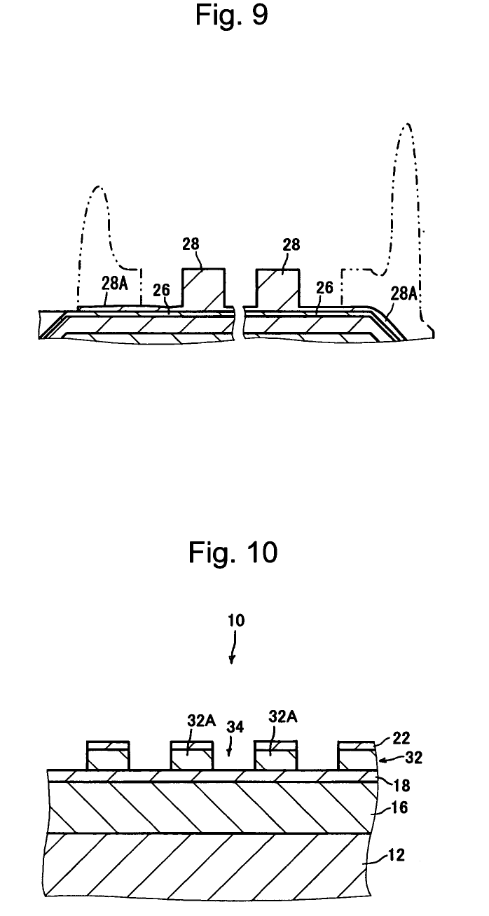

Next, as shown in FIG. 9, the resin material 28 is etched, and more resin material 28 is removed from the edge portions 28A than from the other portion (S108). In the first exemplary embodiment, wet etching is used. Specifically, the workpiece 10 is immersed in a predetermined solvent, and the edge portions 28A of the resin material 28 are thereby allowed to be dissolved and removed. Acetone, ethanol, PGMEA (propylene glycol monoethyl ether acetate), butyl acetate, or the like maybe used as the solvent. In the portion excluding the edge portions 28A, since the resin material 28 has increased in molecular weight during the polymerization and/or crosslinking reaction and has been transformed into a solid state, the resin material 28 is not easily dissolved in the solvent. Meanwhile, in the edge portions 28A, the polymerization and/or crosslinking reaction have been suppressed, and therefore the resin material 28 is easily dissolved in the solvent. Accordingly, the edge portions 28A of the resin material 28 can be selectively removed in an efficient manner. It is sufficient that the edge portions 28A of the resin material 28 be removed such that the thickness thereof is close to the thickness of the resin material 28 in the concave portions in the portion excluding the edge portions 28A as shown in FIG. 9. The edge portions 28A of the resin material 28 may be removed completely. In FIG. 9, the chain double-dashed lines represent the resin material 28 removed by etching from the edge portions 28A.

Next, as shown in FIG. 10, according to the concavo-convex pattern of the resin material 28, the recording layer 20 is processed by means of dry etching into a concavo-convex pattern (S110). Specifically, the resin material 28 at the bottom of each concave portion is first removed by means of RIE using an oxygen-based gas. Note that the resin material 28 in the convex portions is partially removed, but the remaining convex portions have a height corresponding to the step height of the transferred concavo-convex pattern. Subsequently, according to the concavo-convex pattern of the resin material 28, the second mask layer 26 at the bottom of each concave portion is removed by means of, for example, IBE using an inert gas such as Ar, Kr, or Xe, and the first mask layer 22 at the bottom of each concave portion is removed by means of, for example, RIE using a halogen-based gas. Furthermore, the exposed portion of the continuous recording layer 20 at the bottom of each convex portion is removed by means of, for example, IBE using an inert gas such as Ar. In this manner, the continuous recording layer 20 is divided into a large number of the recording elements 32A, and the recording layer 32 having the concavo-convex pattern is formed. At this point, almost all the resin material 28 and the second mask layer 26 over the recording elements 32A are removed. The first mask layer 22 remaining over the recording elements 32A is completely removed by means of, for example, RIE using an oxygen-based gas, a halogen-based gas, or a hydrogen-based gas such as NH₃ or H₂. In this manner, the second mask layer 26 and the resin material 28 over the first mask layer 22 are removed completely.

As described above, in the resin material spreading step (S104), the edge portions 28A of the resin material 28, i.e., the resin material 28 around the center hole 12A and in the outer circumferential portion, can be formed to have a thickness significantly greater than that of the other portion. Even in such a case, by projecting the energy rays onto the resin material 28 such that the irradiation energy is greater on the portion excluding the edge portions 28A of the resin material 28 than on the edge portions 28A, the resin material 28 can be cured such that the curing reaction of the resin material 28 proceeds to a greater extent in the portion excluding the edge portions 28 than in the edge portions 28. In this manner, during the etching in the resin material etching step (S108), the etching rate for the edge portions 28A of the resin material 28 can be greater than the etching rate for the other portion of the resin material 28. Therefore, more resin material 28 can be removed from the edge portions 28A than from the other portion. Accordingly, by selectively etching the edge portions 28A of the resin material 28 in which the thickness tends to be greater than that of the other portion, the resin material 28 used for processing the recording layer 32 into the concavo-convex pattern can be removed completely.

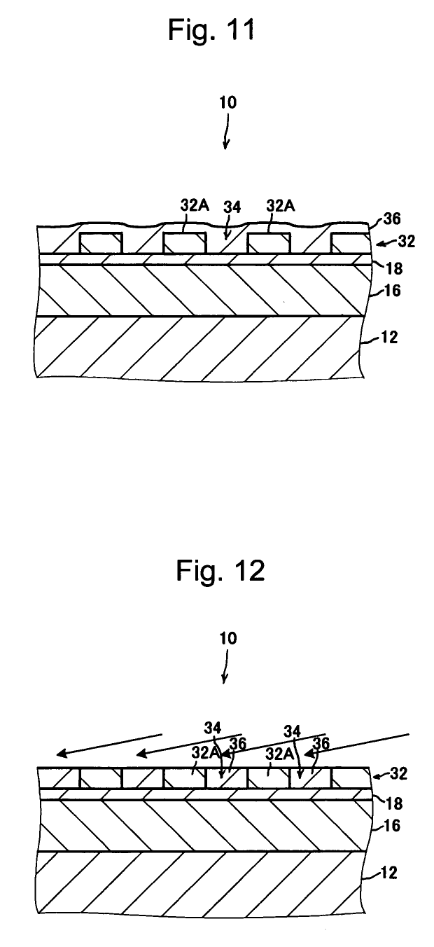

Next, as shown in FIG. 11, the filling material 36 is deposited over the recording layer 32 having the concavo-convex pattern by means of sputtering or bias sputtering, and therefore the concave portions 34 between the recording elements 32A are filled with the filling material 36 (S112). Note that when a resin material is used as the filling material 36, the filling material 36 is deposited by means of a spin coating method.

Next, as shown in FIG. 12, the filling material 36 deposited above the upper surfaces of the recording elements 32A (the surfaces on the side opposite to the substrate 12) is removed by means of IBE using an inert gas such as Ar, whereby the surfaces of the recording elements 32A and the filling material 36 are flattened (S114). In FIG. 12, the arrows schematically represent the direction of irradiation with the processing gas.

Next, the protection layer 38 is formed over the recording elements 32A and the filling material 36 by means of a CVD method (S116).

Moreover, the lubrication layer 40 is applied to the protection layer 38 by means of a dipping method (S118). In this manner, the magnetic recording medium 30 shown in FIG. 2 is completed.

A description will now be given of a second exemplary embodiment of the present invention.

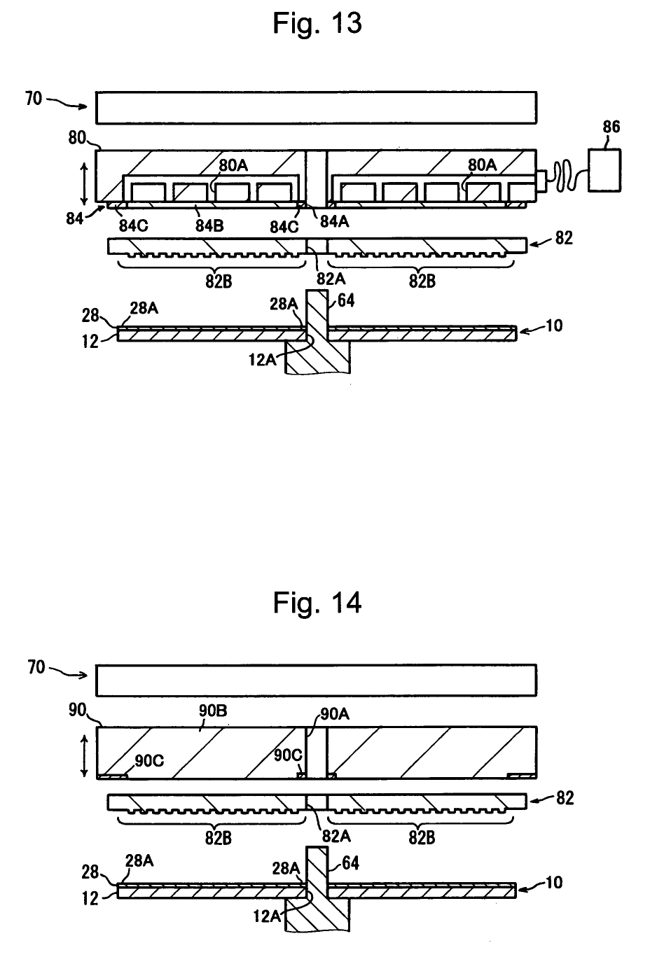

In the first exemplary embodiment, in the transferring step (S106), the stamper 50 is used which includes the base portion 50C allowing the energy rays to pass therethrough and the masks 50D which can shield the edge portions 28A of the resin material 28, which correspond to the edge portions of the transferring portion 50B, from the energy rays. However, in the second exemplary embodiment, in the transferring step (S106), a mask 84 is placed between a stamper stage 80 and a stamper 82 as shown in FIG. 13.

The stamper stage 80 has a plurality of suction holes 80A each of which is in communication with a negative pressure generator 86 and has an opening in the lower surface of the stamper stage 80. Hence, the stamper stage 80 can hold the mask 84 on the lower surface by suction due to negative pressure.

The stamper 82 has a substantially disk-like shape with a center hole 82A and includes a transferring portion 82B similar to the transferring portion 50B of the stamper 50 in the first exemplary embodiment. Note that the stamper 82 does not have a mask.

The mask 84 has a substantially disk-like shape with a center hole 84A and includes: a base portion 84B which allows energy rays such as ultraviolet rays to pass therethrough; and mask portions 84C which can shield the edge portions 28A of the resin material 28 from the energy rays projected onto the resin material 28 (being a target to be transferred to) of the workpiece 10. Since other components are the same as those in the first exemplary embodiment, the same reference numerals as in FIGS. 1 to 12 are used, and redundant description is omitted as appropriate.

Also in the case in which the mask 84 is placed between the stamper stage 80 and the stamper 82 as described above, the resin material 28 can be irradiated with the energy rays such that the irradiation energy on the portion excluding the edge portions 28A of the resin material 28 is greater than the irradiation energy on the edge portions 28A. In this manner, the resin material 28 can be cured such that the curing reaction of the resin material 28 proceeds to a greater extent in the portion excluding the edge portions 28A than in the edge portions 28A. Accordingly, in the resin material etching step (S108), more resin material 28 can be removed from the edge portions 28A than from the other portion, so that the resin material 28 used for forming the recording layer 32 having the concavo-convex pattern can be removed completely.

Next, a description will be given of a third exemplary embodiment of the present invention.

In the second exemplary embodiment, the mask 84 is placed between the stamper stage 80 and the stamper 82 in the transferring step (S106). However, in the third exemplary embodiment, a stamper stage 90 which can shield the edge portions 28A of the resin material 28 from the energy rays is used in the transferring step (S106) as shown in FIG. 14. Note that a mask is not placed between the stamper 82 and the stamper stage 90. Since other components are the same as those in the second exemplary embodiment, the same reference numerals as in FIG. 13 are used, and redundant description is omitted as appropriate.

The stamper stage 90 has a substantially disk-like shape with a center hole 90A and includes: a base portion 90B which can apply pressure to the resin material 28 through the stamper 82 and allows the energy rays to pass therethrough; and masks 90C which can shield the edge portions 28A of the resin material 28, which correspond to the edge portions of the transferring portion 82B of the stamper 82, from the energy rays projected onto the resin material 28 through the base portion 90B and the stamper 82.

Also in the case in which the stamper stage 90 is used which includes the masks 90C and can shield the edge portions 28A of the resin material 28 from the energy rays as described above, the resin material 28 can be irradiated with the energy rays such that the irradiation energy on the portion excluding the edge portions 28A of the resin material 28 is greater than the irradiation energy on the edge portions 28A. In this manner, the resin material 28 can be cured such that the curing reaction of the resin material 28 proceeds to a greater extent in the portion excluding the edge portions 28A than in the edge portions 28A. Accordingly, in the resin material etching step (S108), more resin material 28 can be removed from the edge portions 28A than from the other portion, so that the resin material 28 used for forming the recording layer 32 into the concavo-convex pattern can be removed completely.

As described above, the edge portions 28A of the resin material 28 are shielded from the energy rays by using the stamper 50 including the masks 50D in the first exemplary embodiment, by placing the mask 84 between the stamper stage 80 and the stamper 82 in the second exemplary embodiment, or by using the stamper stage 90 including the masks 90C in the third exemplary embodiment. However, the edge portions 28A of the resin material 28 may be shielded from the energy rays, for example, by placing a mask between the irradiation apparatus 70 and the stamper stage 62. Moreover, an irradiation apparatus having a mask may be used.

In the second exemplary embodiment, the stamper stage 80 holds the mask 84 through negative pressure. However, the mask 84 may be bonded to the stamper stage.

In the first and third exemplary embodiments, the stampers 50 and 82 and the stamper stages 62 and 90, respectively, are independent of each other and are successively moved down toward the workpiece 10. However, the stamper may be held by the stamper stage through negative pressure or adhesion, so that they are integrally moved down toward the workpiece 10.

In the first to third exemplary embodiments, the energy rays are projected onto the resin material 28 through the stamper 50 or 82. However, when the materials for the substrate 12, the recording layer 20, and other layers constituting the workpiece 10 allow the energy rays to pass therethrough, so that the energy rays can pass through the workpiece, the energy rays maybe projected onto the resin material 28 through the workpiece 10. In such a case, the irradiation apparatus is placed on the side opposite to the resin material-applied surface of the workpiece, and the mask is placed between the workpiece and the irradiation apparatus. Alternatively, an irradiation apparatus having a mask may be used.

In the first to third exemplary embodiments, the resin material 28 is etched by means of wet etching in the resin material etching step (S108). However, more resin material may be removed from the edge portions than from the other portion by means of dry etching. Specifically, dry etching such as RIE using a halogen-based gas such as CF₄, C₂F₆, C₂F₈, or SF₆, or an oxygen-based gas such as O₂ or O₃ as a processing gas or IBE using an inert gas such as Ar or Xe may be used. As described above, in the portion irradiated with the energy rays, the resin material increases in molecular weight during the polymerization and/or crosslinking reaction and is transformed into a solid state. In the portion shielded from the energy rays, the polymerization and/or crosslinking reaction are suppressed. When dry etching is used, the etching selection ratio between the portion irradiated with the energy rays and the portion shielded from the energy rays is often smaller than that in wet etching. Therefore, the thickness of the edge portions may not be reduced to a thickness comparable to that of the other portion of the resin material. Even in such a case, the effect of suppressing the remaining amount of the resin layer used for processing the recording layer into the concavo-convex pattern can be obtained to some extent by reducing the difference in thickness between the edge portions and the other portion of the resin material to some extent.

In the first to third exemplary embodiments, the inner and outer circumferential edge portions 28A of the resin material 28 are shielded from the energy rays in the transferring step (S106), and more resin material 28 is removed from the inner and outer circumferential edge portions 28A than from the other portion in the resin material etching step (S108). However, in some cases only one of the inner and outer circumferential edge portions 28A of the resin material 28 can be formed to have a thickness significantly greater than that of the other portion of the resin material 28 in the resin material spreading step (S104). In such a case, only the edge portion formed to have a significantly greater thickness may be shielded from the energy rays in the transferring step (S106), and more resin material may be removed only from the edge portion formed to have a significantly greater thickness than from the other portion in the resin material etching step (S108).

In the first to third exemplary embodiments, the center hole 12A is formed in the workpiece 10 and the magnetic recording medium 30. However, various exemplary embodiments of the present invention are applicable even when a magnetic recording medium not having a center hole is manufactured.

In the first to third exemplary embodiments, the recording layer 20 is divided thoroughly in the recording layer processing step (S110). However, a recording layer having a concavo-convex pattern in which the recording layer is continuous at the concave portions may be formed by processing the recording layer to midway in the thickness direction.

In the first to third exemplary embodiments, the soft magnetic layer 16 and the seed layer 18 are formed below the recording layer 20 (32). However, the configuration of the layers below the recording layer 20 (32) may be changed appropriately according to the type of the magnetic recording medium. For example, an antiferromagnetic layer and an underlayer may be formed below the soft magnetic layer 16. Moreover, one of the soft magnetic layer 16 and the seed layer 18 may be omitted. Furthermore, the recording layer 20 (32) may be formed directly on the substrate 12.

In the first to third exemplary embodiments, examples are shown in which the recording layer 32 is provided on one side of the substrate 12. However, various exemplary embodiments of the present invention are applicable even to the case in which a magnetic recording medium having a recording layer on both sides of the substrate is manufactured.

In the first to third exemplary embodiments, the magnetic recording medium 30 is a discrete track medium of a perpendicular recording type in which the recording elements 32A are formed in a track shape in the data area. However, various exemplary embodiments of the present invention are applicable even to the manufacturing of patterned media including recording elements formed by circumferentially dividing tracks and of magnetic disks including recording elements formed in a spiral shape. Moreover, various exemplary embodiments of the present invention are applicable even to the manufacturing of magneto-optical disks such as MO disks, of heat assisted type recording disks for which both magnetism and heat are utilized, and of magnetic recording media, such as magnetic tapes, having a shape different from a disk-like shape.

What is claimed is:

1. A method for manufacturing a magnetic recording medium, comprising:
a resin material spreading step of spreading a resin material which can be cured by being irradiated with energy rays over a continuous recording layer of a workpiece;
a transferring step of bringing a stamper including a transferring portion having a predetermined concavo-convex pattern formed therein into contact with the resin material to transfer the concavo-convex pattern to the resin material and projecting energy rays onto the resin material such that irradiation energy of the energy rays is greater on a portion excluding an edge portion of the resin material than on the edge portion, whereby the resin material is cured such that a curing reaction of the resin material proceeds to a greater extent in the portion excluding the edge portion than in the edge portion; and
a resin material etching step of etching the resin material to remove the resin material such that an amount of the resin material removed is greater in the edge portion than in the portion excluding the edge portion.

2. The method for manufacturing a magnetic recording medium according to claim 1, wherein
wet etching is used in the resin material etching step.

3. The method for manufacturing a magnetic recording medium according to claim 1, wherein
in the transferring step, a stamper which allows the energy rays to pass therethrough and can shield the edge portion of the resin material from the energy rays is used as the stamper, and the energy rays are projected onto the resin material through the stamper.

4. The method for manufacturing a magnetic recording medium according to claim 2, wherein
in the transferring step, a stamper which allows the energy rays to pass therethrough and can shield the edge portion of the resin material from the energy rays is used as the stamper, and the energy rays are projected onto the resin material through the stamper.

5. The method for manufacturing a magnetic recording medium according to claim 1, wherein
in the transferring step, a stamper which allows the energy rays to pass therethrough is used as the stamper, and a mask which can shield the edge portion of the resin material from the energy rays and a stamper stage which can apply a pressure to the resin material through the stamper and allows the energy rays to pass therethrough are further used, the mask is placed between the stamper stage and the stamper, and the energy rays are projected onto the resin material through the stamper stage and the stamper.

6. The method for manufacturing a magnetic recording medium according to claim 2, wherein
in the transferring step, a stamper which allows the energy rays to pass therethrough is used as the stamper, and a mask which can shield the edge portion of the resin material from the energy rays and a stamper stage which can apply a pressure to the resin material through the stamper and allows the energy rays to pass therethrough are further used, the mask is placed between the stamper stage and the stamper, and the energy rays are projected onto the resin material through the stamper stage and the stamper.

7. The method for manufacturing a magnetic recording medium according to claim 1, wherein
in the transferring step, a stamper which allows the energy rays to pass therethrough is used as the stamper, and a stamper stage which can apply a pressure to the resin material through the stamper, allows the energy rays to pass therethrough and can shield the edge portion of the resin material from the energy rays is further used, and the energy rays are projected onto the resin material through the stamper stage and the stamper.

8. The method for manufacturing a magnetic recording medium according to claim 2, wherein
in the transferring step, a stamper which allows the energy rays to pass therethrough is used as the stamper, and a stamper stage which can apply a pressure to the resin material through the stamper, allows the energy rays to pass therethrough and can shield the edge portion of the resin material from the energy rays is further used, and the energy rays are projected onto the resin material through the stamper stage and the stamper.

9. A stamper comprising:
a base portion which includes a transferring portion having a predetermined concavo-convex pattern formed therein and allows predetermined energy rays to pass therethrough; and
a mask capable of shielding an edge portion of a target corresponding to an edge portion of the transferring portion from the energy rays projected onto the target.

10. A transferring apparatus comprising:
a stamper stage which can apply a pressure to a target through a stamper including a transferring portion having a predetermined concavo-convex pattern formed therein, allows predetermined energy rays to pass therethrough, and can shield an edge portion of the target corresponding to an edge portion of the transferring portion of the stamper from the energy rays projected onto the target.

11. A method for forming a resin mask, the method comprising:
a resin material spreading step of spreading a resin material which can be cured by being irradiated with energy rays over a workpiece;
a transferring step of bringing a stamper including a transferring portion having a predetermined concavo-convex pattern formed therein into contact with the resin material to transfer the concavo-convex pattern to the resin material and projecting energy rays onto the resin material such that irradiation energy of the energy rays is greater on a portion excluding an edge portion of the resin material than on the edge portion, whereby the resin material is cured such that a curing reaction of the resin material proceeds to a greater extent in the portion excluding the edge portion than in the edge portion; and
a resin material etching step of etching the resin material to remove the resin material such that an amount of the resin material removed is greater in the edge portion than in the portion excluding the edge portion.
